(19) United States
(12) Patent Application Publication
(10) Pub. No.: US 2018/0308116 A1
(43) Pub. Date: Oct. 25, 2018

(54) SYSTEMS AND METHODS FOR IMPLEMENTING A REACTIVE AND TRANSACTIVE ECOSYSTEM

(71) Applicant: Frank S. MAGGIO, Seminole, FL (US)

(72) Inventor: Frank S. MAGGIO, Seminole, FL (US)

(21) Appl. No.: 15/955,674

(22) Filed: Apr. 17, 2018

Related U.S. Application Data
(60) Provisional application No. 62/486,309, filed on Apr. 17, 2017.

(51) Int. Cl. G06Q 30/02; G06Q 20/36

(52) U.S. Cl. CPC G06Q 30/0218; G06Q 20/3672; G06Q 30/0245; G06Q 30/0212

(57) ABSTRACT

A system and method are provided for implementing a uniquely automated reactive ecosystem to provide users/consumers a secure environment in which to engage streaming content in a reportable manner to an advertising component. Communications are established between a user electronic data exchange device and a centralized server that coordinates exchange of query information with a user regarding content of an associated linear television or live stream event. The disclosed systems and methods uniquely adapt data exchange to score a user's attention to data content, including advertising content, and to provide to the user an incentive scheme for attention to the content of portions of the linear television or live stream event.

This application claims the benefit on U.S. Provisional Patent Application No. 62/486,309 entitled “Reactive and Transactive Ecosystem,” filed on Apr. 17, 1017, the disclosure of which is hereby incorporated by reference herein in its entirety.

### BACKGROUND

### 1. Field of the Disclosed Embodiments

This disclosure is directed to a reactive and transactive operating environment in which passive data delivery devices such as, for example, televisions, deliver content that is related to content that is deliverable in a user exchange environment including one or more user portable electronic devices in order to confirm user attention content delivered from the passive data delivery devices.

### 2. Related Art

Globally, mass media advertising has evolved in a one trillion-dollar annual industry. Through advertising, brands and agencies attempt to convey information to consumers in a manner that creates interest in the advertised products, ideally in a powerful and repeated manner that is enough to drive consumer purchase and repurchase of specifically advertised products.

Mass media advertising has likewise evolved from the nascent days of radio as the delivery medium through the emergence and expansion of television as the now-conventional and “preferred” medium to reach the masses for entertainment, and therefore advertising. The evolution continues. Over the last three generations, advertising-supported media has proliferated, and the amount and/or frequency of advertising has multiplied as the medium has changed. Three network news and entertainment stations have evolved into dozens and dozens of news and entertainment and sports and advertising and other channels.

Today, there is an expanding trend toward reaching the consuming public via delivery of all versions of advertising-supported media to individual users' personal electronic devices, including portable and/or tablet computers, mobile cellular telephones, smart phones, and all manner of, for example, fixed-location changeable electronic displays. Consumers, particularly those that carry one or more portable personal electronic devices, which now may include wearable input/output (I/O) devices, have become increasingly drawn to actively using these portable personal electronic devices, even in environments once primarily used for passively watching television. The portable personal electronic devices accompany the users at almost all times, providing those users with the ability, and the increasingly insatiable opportunity, to multi-task in their acquisition and sharing of information in a real-time user-involved information exchange experiences.

These real-time user-involved information exchange experiences include virtually all manner of electronically-enabled communication activities, including, but not limited to, engagement with social media, electronic gaming (including group participation) for active entertainment experiences, selection of particular media content for passive entertainment experiences, and information exchange through email, messaging applications, and other forms of user-to-user (or user-to-a collective of users) communication. This engagement, via the individual users' portable personal electronic devices, continues, and often dominates, even as the users are exposed to advertising presented on televisions, desktop computers, and other not-so-portable passive data and/or entertainment content delivery means. In fact, consumers have developed a near twitch-like response to multi-task, or “otherwise” engage, when advertising, which is often considered disruptive, interrupts them, like an uninvited guest.

While providing the ability for consumers to do more, more often and at more locations, user portable personal electronic and/or “smart” devices, and their inherently distractive nature, contribute to severely diminished advertising efficacy, particularly with regard to advertising content delivered via traditional passive delivery channels. Advertising content is just there, and is often discounted as a user's attention is directed to other forms of “more important” personal interactive information exchange. It is thus harder to reach consumers with advertising, even during “live” programs where DVR-enabled time-shifted ad skipping, for example, is unavailable. Engagement with the personal electronic devices, including smart phones, and with content-related applications, deter engagement with brands.

### SUMMARY

It may be advantageous, in view of the above distractive nature generally imputed to one's portable personal electronic devices, to find some manner by which to harness that distraction such that advertising content may be delivered in a measurable manner through a cooperative combination of passive content delivery channels and user interactive portable personal electronic devices.

Exemplary embodiments of the systems and methods according to this disclosure may harness consumer awareness of a trend in the distribution of applications, or “apps,” and computer programs, which are often inexpensively priced, or free, offering novel new functionality that often draws the attention on the interaction of masses of users.

Exemplary embodiments may harness the power of consumer use of technology services, while at home and/or work in a manner in which the retail ecosystem may further its efforts to strike a balance of individual privacy and data rights, with the availability of the of a wealth of individualized data for use between all constituents (retailers, marketers, consumer packaged goods (or CPG) companies, research and analytics companies and consumers).

In embodiments, an ability to obtain, and analyze, consumer data (behavioral and transactional) as a form of Business Intelligence (or BI) referred to as Customer Intelligence (or CI), increases. In like manner, the draw to use that data as part of targeted customer engagement campaigns increases. This confluence of circumstances has led to a steadily increasing the tension between the rights of the consumers creating the data and the others who seek to effectively employ that data. In embodiments, the disclosed systems and methods seek to strike an appropriate balance between competing objectives of users in maintaining their privacy, and advertisers in reaching targeted audiences for their delivered content.

Exemplary embodiments according to this disclosure may refer to an inventive concept toward consumer-reactive engagement via user portable personal electronic devices. Embodiments will be referred to as the “React” app, which may be considered a centerpiece of, and an implementing technology for a “Reactive ecosystem.” In embodiments, the Reactive ecosystem may represent a multi-point marketing and retail environment that provides consumers with a means of using technology-enabled (or Internet-enabled) mobile phones, network-connected and Internet-connected computers (including tablets and/or portable computers), wearable I/O devices, retail kiosks and other digital data content-delivery means, which necessarily include a means for entering into a reactive retail environment of reactive advertising campaigns to facilitate consumer activities that may include, but are not limited to, exploring retail (physical and online) locations, becoming informed about brands, products, and services (as well as advertising for those brands, products and services), accessing, sharing and using retail purchase data, and conducting retail transactions in an environment that provides efficiencies to consumers, retailers and manufacturers.

Embodiments of may provide empowered consumers with a novel means of data exchange through text-enabled, or network connected, mobile phones and smart displays, network-connected computers, wearable I/O devices, and retail kiosks, for entering into myriad brand-friendly reactive experiences.

Embodiments may allow for exploring, accessing, sharing and using individual consumer (user) retail purchase data for convenient and economical acquisition of consumer goods, in a protected, respectful, and rewarding way, protecting, respecting and rewarding consumers.

These and other features, and advantages, of the disclosed systems and devices are described in, or apparent from, the following detailed description of various exemplary embodiments.

### BRIEF DESCRIPTION OF THE DRAWINGS

Various exemplary embodiments of the disclosed systems and methods for implementing a reactive and transactive operating environment in which passive data delivery devices such as, for example, televisions, deliver content that is related to content that is deliverable in a user exchange environment including one or more user portable electronic devices in order to confirm user attention content delivered from the passive data delivery devices, will be described, in detail, with reference to the following drawings, in which:

FIG. 1 illustrates a block diagram of an exemplary system for implementing an advanced automated reactive ecosystem according to the varied schemes outlined in detail below in this disclosure; and

FIG. 2 illustrates a flowchart of an exemplary method for implementing an advanced automated reactive ecosystem according to this disclosure.

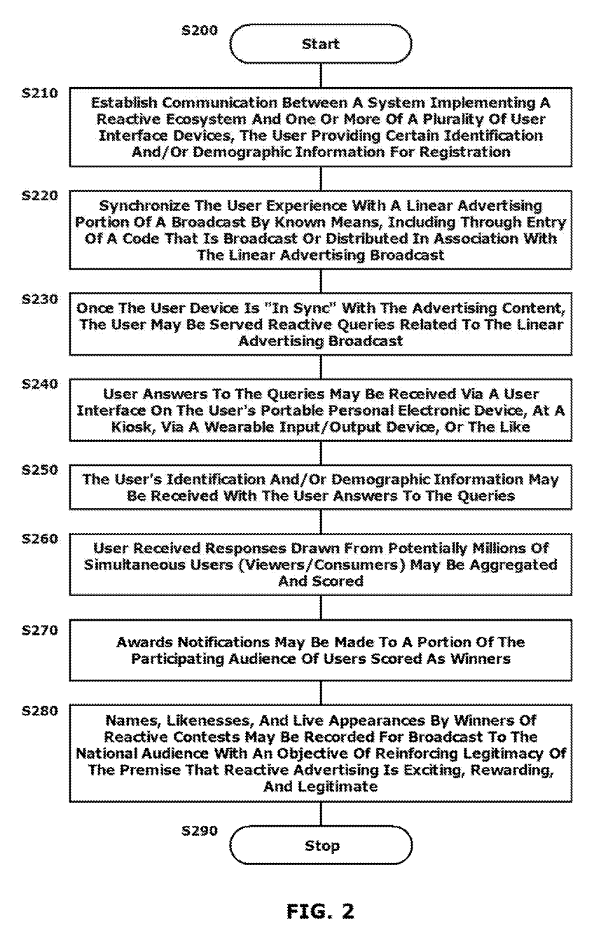

### DETAILED DESCRIPTION OF EMBODIMENTS

The disclosed systems and methods for implementing a reactive and transactive operating environment in which passive data delivery devices such as, for example, televisions, deliver content that is related to content that is deliverable in a user exchange environment including one or more user portable electronic devices in order to confirm user attention content delivered from the passive data delivery devices may particularly describe a capacity by which user attention to data content regardless of the delivery medium is measurable.

Embodiments according to this disclosure may leverage the pathway provided by commercial social media content and exchange platforms including, for example, Facebook®, Instagram®, and Snapchat® as examples of “free” services that initially contained no advertising. Once the companies that create these apps acquire a mass audience, and have essentially habituated users to almost-without-thinking using their platforms on a regular basis, often inviting friends to adopt the apps and behaviors as well, the companies transition to engagement in increasingly aggressive advertising tactics.

According to the current scheme, while engaging these “free” apps, consumers have their usage data, engagement behaviors, and content (words, photos, thoughts, and personalities) used to the benefit of the technology company, often in a form of presenting “better” or targeted advertising. Consumer data may be exchanged (sometimes sold, albeit that such tactics are gaining public disdain), aggregated, and melded, allowing content delivery companies to triangulate portions of supposedly “anonymized” data to a point where individual users can be virtually personally identified.

As noted above, exemplary embodiments are directed at attempting to ensure that some balance is struck between individual user privacy concerns and limitations on data sharing with the exigencies of an increasingly animated and competitive retail ecosystem. Put another way, the disclosed systems seek to ease the tension in the tug-of-war between individual privacy and data rights and the capacity of today's data-gathering systems to collect and analyze a wealth of individualized data for use between all constituents (retailers, marketers, consumer packaged goods (or CPG) companies, research and analytics companies and consumers).

A modicum of consumer protection may still be maintained even as the ability to obtain, and analyze, consumer data (behavioral and transactional) as BI and/or CI, increases. Those collections of data for use as part of targeted customer engagement campaigns is invaluable, even as the effects on a particular consumer, or consuming population are often overlooked. The exemplary embodiments according to this disclosure seek to insulate the individual users in a selectively targeted manner. In this regard, the disclosed embodiments seek to ease what has to date arisen as a confluence of circumstances that places in tension the rights of the consumers creating the data and others who seek to effectively employ that data.

Consider the following definitions of specific roles:

For consumers, online shopping and social networking behavior remain spread typically between multiple websites and companies. Participation in casual electronic gaming continues to thrive online. Mobile portable electronic devices including, for example, smart phones continue to increase in their prevalence as dominant interactive data exchange devices. In other words, such devices have become generally ubiquitous among the consumer population. Here, the belief that most services should be and remain free for their use predominates the consumer mindset.

Conversely, there is currently no single Internet website that consolidates all transactions for easy retrieval; no singular method of tying all purchases to one central username or password. And, there is no firm that has become the trusted source for housing and monetizing consumers' behavioral and transactional data. Companies like ValPak® and Catalina Marketing® have tried to transition their business models into new digital methods of couponing with limited success. One can easily surmise where use of a particular coupon scheme may aid in “tracking” a particular consumer's market interaction. Efforts in this regard, e.g., the transition to make mobile phones a central part of the consumer transaction experience, have, however, been slow to take hold even as a 90+% of the adult population in the U.S. now routinely carry mobile phones, an overwhelming percentage of which are smart phones.

Embodiments according to this disclosure may fill in this gap based on the understanding of the popular use of portable personal electronic devices, while being sensitive to the condition that consumer data is being increasingly handled and sold by third parties, thus eroding consumer privacy. With increasing pressure to tighten security, consumers are faced with the power potential to take back their information and to monetize that information in new user-controlled ways, or essentially to use it as currency in the purchase of better customer services, and products and services at lower prices.

Bolstered by the capacity for social media to connect people, consumers are coming to understand that there is strength in numbers. Crowd sourcing, affinity points, group feedback, and fun, are all converging into a new online community, which has the potential to facilitate better prices, better services, and an overall more convenient and pleasurable advertising and shopping experience.

With the above as a backdrop, the disclosed systems and methods seek to reduce the intrusive nature, or “feel,” of conventional advertising. An objective is to reduce or effectively eliminate “ad skipping,” which has become very commonplace. The disclosed systems and methods may advantageously affect consumer behavior by rewarding consumers for paying attention, in a measurable manner and according to a reportable scheme to advertising content. The disclosed schemes implement a system by which consumer attention to particular ad content is measured, while on intrusively collecting demographic and opinion feedback as a part of a new, honest, rewarding, and consumer-centric transactional relationship. It is recognized that many online firms have, with varying degrees of success, attempted to merge some behavioral data with transaction data. Yet, these efforts have proven only limitedly successful by maintaining an impersonal relationship between the retailers, and their vendor partners, and the consuming population that they are attempting to address, some would say manipulate.

The disclosed schemes attempt to better harness the tremendous capabilities of the data aggregation companies or data aggregators (particularly retail based CI companies), which are currently unable to fully exploit their massive databases of transactional information, due to: a) their lack of ownership of census-level demographic information; and b) competitive concerns on the part of their merchant partners. Providing loyalty shopping services for others, the retailer “owns” the consumer and the data, relegating the conventional data aggregator to developing secondary and tertiary relationships with CPG producers, manufacturers, and agencies. Investments in coupon printers, and/or dated loyalty card programs, are currently subject to deteriorating value, due to web-based methodologies, right-now digital content delivery and other technological advances in eCommerce, coupled with known changes in consumer behavior.

A key to value and long-term viability for the data aggregators as service providers is to develop relationships with the agencies, and more importantly, the body of consumers—not just with a partial panel or subset of existing transactions. The challenge is to bring a new value to the retailers, and exchange this new value for access to the consumer information, and the right to leverage that information in a manner that provides value back to the consumer in a trusted environment. In exchange for better service for the consumers, access to consumers' transactions may be provided in a non-threatening and trusted manner. In this endeavor, a challenge exists in finding new uses for existing hardware and distribution channels, particularly where efforts may be directed at accessing the technology deployed by others (such as mobile phone service providers or social network infrastructures) to complement existing services and hardware deployment.

For retailers and e-Tailers, conventional loyalty programs provide an overwhelming amount of data concerning particular retailers' customers' behavior in-store, but may offer little insight into their behavior outside of the store. Consumers often tire of carrying loyalty cards, and seek an easier way to obtain and leverage their “credit” for frequently shopping with a particular retailer. Retailers are concerned that their customers' data will get into the hands of competitors, but this closed environment may become more valuable if supplemented by other transaction—and media consumption—behavior.

The questions remain—“What are the risks and rewards of opening my company's insights into our customers' behavior up to the broader, competitive market? And what if my customers demand that they be able to collect and aggregate their consumption behavior across all commerce channels—will I refuse? And if so, will I damage the relationship my customers, or even lose some significant percentage of my customers?” The failure to produce clear answers to the questions of how, or whether, to leverage customer data, has left many retailers paralyzed in a dated paradigm. Individual retailers may collect and possess enormous amounts of data with no clear purpose, while losing value as the data ages, and no indication as to the ongoing relevance of the mountain of data they hold.

As economies weaken, there is a real hunger for better data, better targeting, proven efficacy, and better use of staff and assets. The Internet has brought the potential of developing meaningful, personally identifiable relationships with loyal users into sight, but access is being territorially guarded by retailers. “Reach” and “frequency” continue to be compelling concepts, but direct access to a broad and interdependent consumer base has the potential to support superior transactions through innovative marketing techniques including an ability to control and customize the type and frequency of messages to individual consumers and groups of consumers. Additionally, for a select number of CPG technology providers, a mature ability to provide ground floor promotional and technological support (and truly appreciated consumer-level branding) to a venture that transforms and democratizes retail transactions may engender powerful long-term ties to consumers and retailers—while also potentially providing first-mover status, and/or temporary category exclusivity.

Consumers increasingly rely upon digital search tools, incentivized marketing (including, for example, coupon websites), and other mediums to learn more about items on sale, new products, bulk discounts, product ingredients, and the like, for the planning and execution of their retail or online shopping.

Mobile wallets and sophisticated technologies like those deployed by certain retailers, and by support companies, provide some level of granularity as to the demography and identity of consumers who actually purchase goods. An ability to link advertising exposure to product consumption is, however, difficult. The disclosed schemes seek to combine transaction level data, with media measurement tools beyond those derived from representative panels or anonymous audience collection methodologies, including set top boxes or IP addresses to provide marketers with a quantum advantage over what was, at-best, an imprecise methodology for directly linking an advertisement or promotion to a purchase. The traditional reliance on browsers, social media sites, set top boxes, mobile phones, and computers, as sources for creating and harvesting data for technology and media companies to merge with transaction-level data has not changed as it has advanced to a point where individual consumers are being tracked, targeted and ambushed with more and more advertising, in the name of serving them “better” advertising. In reality, many consumers are made increasingly uncomfortable with this approach for myriad reasons, including that feeling that their “personal space” is being electronically violated.

These feelings are exacerbated even with advancing technology in instances in which, ton the transactional level, and despite deployment of EMV-chip enabled credit and debit cards, consumer identity theft, and incidents of fraudulent transactions, remain rampant. So too do web-based methods used by hackers and other nefarious individuals to derive consumer access data, including usernames, passwords, and other personally identifiable information that can be used to facilitate the making of unauthorized transactions. Consumer concerns regarding their information being stolen when it is too freely shared in the retail marketplace has hindered certain advanced payment methods from gaining broad consumer or merchant acceptance.

All the while, consumers are also becoming increasingly distrustful of advertising, in general and as a result may generally seek to avoid it. A byproduct of such behavior among consumers is that they may not be aware of, or armed with, valuable information available within mass media advertising, which is an important aspect of the product purchase cycle. Individual consumers that seek specific goods may only access certain merchant channels that do not expose those consumers to competitive and “better” purchase options. This behavior, coupled with widespread ad avoidance, can lead to a decline in sales for some companies, interestingly motivating those companies to become even more aggressive in their advertising and data collection and consumer purchase tracking behavior, the precise outcomes the consumers have sought to avoid.

The disclosed schemes seek to overcome the concerns with which the traditional advertise-to-purchase cycle is so deeply infected. Active engagement with individual consumers in a fun, reactive manner that invites consumer willingness to exchange data in an unobtrusive exchange environment strikes directly at, and seeks to overcome, the attitude of indifference toward advertising, combined with the impulse to multi-task, that provides individual brands and networks with a particular set of previously unaddressed challenges, particularly in an environment in which dated metrics by which to measure one's return on investment (ROI) for the advertising dollars have proven increasingly fallible.

The disclosed schemes seek to fill the gap existing in that there is no practical single application, or ecosystem, that consumers can rely on to serve them effective advertising, promote their exploration of products and services, provide for secure authentication, manage their identifying credentials and bank/credit/debit accounts, and support their capacity to transact, in a completely respectful, secure, rewarding, and opt-in manner. Such an ecosystem, once having gained the trust of consumers, may provide a new, positive and engaging environment in which consumers and brands may transact business in a manner consistent with the desires of the individual consumers. According to the disclosed schemes, the administrator or host of such an ecosystem, a transparently brand-friendly, consumer protected community resource provider, may deploy and enforce policies, practices, and technology to house and manage all aspects of this environment.

The disclosed systems and methods provide to the retail marketplace a means by which to at least change the consumer attitude of indifference toward ads and brands to a more strikingly positive attitude of gratitude and appreciation. This outcome may be accomplished by turning the tools of distraction that permeate the marketplace into tools of reaction and interaction, via a new form of mobile application and platform that combines all the most vital market-related functions within a single ecosystem.

In this disclosure, reference will be made to the inventive concept being embodied in what will be called the “React” app as a centerpiece of, and an implementing technology for, a “Reactive ecosystem.” The disclosed Reactive ecosystem, implemented via the React app, is a multi-point marketing and retail environment that provides consumers with a means of using technology-enabled (or Internet-enabled) portable personal electronic data exchange devices including tablets, mobile cellular phones, smart phones and the like; network-connected and Internet-connected computers; wearable I/O devices; retail kiosks; and other semi-fixed and/or mobile digital data exchange devices for entering into a reactive retail environment of reactive advertising campaigns. The Reactive ecosystem facilitates, in a user-friendly manner, such consumer activities as exploring retail (physical and online) locations, becoming informed about brands, products, and services (as well as advertising for those brands, products and services), accessing, sharing and using retail purchase data, and conducting retail transactions in an environment that provides efficiencies to consumers, retailers and manufacturers, all the while being considered by the users as less intrusive into their lives as conventional means.

The disclosed schemes enable empowered consumers to be provided with a novel means of data exchange through text-enabled, or network connected portable personal electronic devices and smart displays, network-connected computers, wearable I/O devices, and retail kiosks, for entering into myriad brand-friendly reactive experiences. Embodiments according to the disclosed schemes, processes and/or techniques may allow for exploring, accessing, sharing and using individual consumer (user) retail purchase data for convenient and economical acquisition of consumer goods, in a protected, respectful, and rewarding way, protecting, respecting and rewarding consumers.

A powerful, deployable strategy has been developed to demonstrate, propagate, and habituate the use of the React app by inviting consumers to follow a three-step process of “Attract, React, Transact.” In many ways, the disclosed schemes draw parallels from the method used by individuals for creating meaningful relationships, including interpersonal relationships. For example, the development of many human relationships begins with some effort at attracting another individual, reacting and interacting with that individual in a manner that tests compatibility and affinity in support of the objectives of the relationship leading to the potential of a resultant transaction.

In business, brands attract consumers via advertising and merchandising, desiring that attracted consumers will react to offers, information and stimulation put forth by the brands, to include potentially interacting via websites and communication networks such as social media, and with an intent of concluding a resulting transaction (and, hopefully, repeat transactions).

To gain a mass audience appeal, the disclosed schemes, implemented via the React app and otherwise, may be deployed to users in a manner that attract a mass audience, allows individuals to use the React app in a positive and rewarding manner that stimulates increased use, to the point that users and the general marketplace will integrate the React app and functionality into the day-to-day operations and norms of the marketplace. The React app may be used to attract consumers to brands, allow consumer and brands to react to one another, and enable secure transactions, thereby weaving the React app into the stream of commerce as an integral function of the overall transaction and positive consumer experience. An objective may be to protect and respect consumers, and reward those consumers for using and trusting the React app in all commercial, transactional and security-related endeavors.

Advertising that is reactive, a Reactive Ad process such as that described in U.S. Pat. No. 6,606,745 (the 745 patent), may be deployed by a significant number of leading advertisers, in unison, and regularly repeated over an extended period, ideally incorporated within highly visible popular culture events. Using processes such as those described in the 745 patent, large clusters of national, big-budget advertisers may be capable of collectively supporting a significant prize pool (drawn, for example, from a percentage of their combined ad spend), that may, given promotion by the brands and networks, attract very large consumer audiences.

These consumer audiences, during the duration of a multi-platform televised event (such as, for example, a game show about commercials), may be invited to view and compete for a significant prize pool per episode. Consumer anticipation may be stimulated with prize pool amounts in a range of, for example, $2 million, which is an amount that exceeds the largest prize awards (made available only occasionally) on any of the legacy reality give-away television shows and traditional game shows.

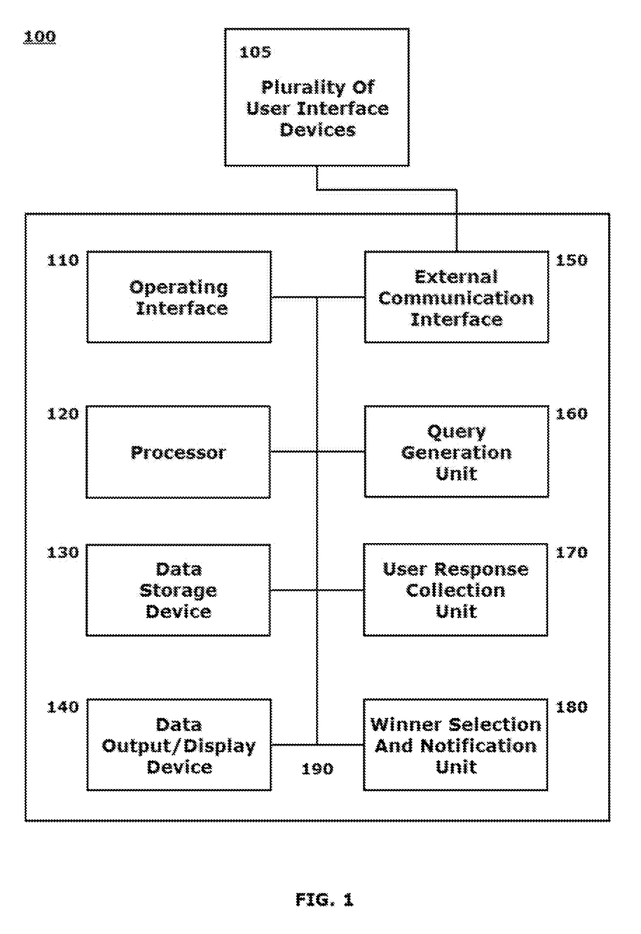

FIG. 1 illustrates a block diagram of an exemplary system 100 for implementing an automated reactive ecosystem scheme according to this disclosure.

The exemplary system 100 may include an operating interface 110 by which a user as a host or administrator may communicate with the exemplary system 100. The operating interface 110 may provide a host or administrator an opportunity to initiate the automated reactive ecosystem scheme, or React app, and to input any parameters appropriate to the conduct and/or control of the automated reactive ecosystem scheme in the manner outlined above and described in detail below, including parameters for aggregation user responses to queries received from a plurality of user-interface devices 105 received via, for example, an external communication interface 150, and establishment of tiebreakers, among other parameters, that may be user-selectable by the host or administrator. The operating interface 110 may be configured as one or more conventional mechanisms common to computing and/or communication devices that may permit the host or administrator to input information to the exemplary system 100. The operating interface 110 may include, for example, a conventional keyboard, a touchscreen with “soft” buttons or with various components for use with a compatible stylus, a microphone by which the host may provide oral commands to the exemplary system 100 to be “translated” by a voice recognition program, or other like device, including any emerging wearable I/O device, by which a user may communicate specific operating instructions and pre-determined parameters setting to the exemplary system 100.

The exemplary system 100 may include one or more local processors 120 for individually operating the exemplary system 100 and for carrying into effect the disclosed schemes in the exemplary system 100. The processor 120 may carry out routines appropriate to operation of the exemplary system 100, and may undertake data manipulation and analysis functions appropriate to the implementation of the reactive ecosystem scheme in any and all of the disclosed variations including, but not limited to, aggregation and/or winter tracking and notification. Processor(s) 120 may include at least one conventional processor or microprocessor that interprets and executes instructions to direct specific functioning of the exemplary system 100, and control of the automated reactive ecosystem scheme implementation in any of the disclosed variations.

The exemplary system 100 may include one or more data storage devices 130. Such data storage device(s) 130 may be used to store data or operating programs to be used by the exemplary system 100, and specifically the processor(s) 130 in carrying into effect the various user reactive schemes, winner identification, and all forms of rewards notification functions of the disclosed reactive ecosystem schemes according to this disclosure. At least one of the data storage device(s) 130 may be used to store the user identification and demographic data as received from the plurality of user interfaces 105, such data being usable to identify individual user preferences, priorities, or accessibility to the reactive ecosystem scheme implemented by the exemplary system 100. The data storage device(s) 130 may include a random access memory (RAM) or another type of dynamic storage device that is capable of storing updatable database information, and for separately storing instructions for execution of system operations by, for example, processor(s) 120. Data storage device(s) 130 may also include a read-only memory (ROM), which may include a conventional ROM device or another type of static storage device that stores static information and instructions for processor(s) 120. Further, the data storage device(s) 120 may be integral to the exemplary system 100, or may be provided external to, and in wired or wireless communication with, the exemplary system 100, including as cloud-based storage components.

The exemplary system 100 may include at least one data output/display device 140, which may be configured as one or more conventional mechanisms that output information to a user, in this case a host or administrator, on a progress of the conduct of the reactive ecosystem scheme implemented by the exemplary system 100. The data output/display device 140 may be used to indicate to the host or administrator information regarding a compilation of the data received from the plurality of user-interface devices 105, as well as a progress of a quiz/query scheme associated with a linear television or streaming broadcast. It is not necessary that the host or administrator monitor the actual conduct of the automated reactive ecosystem scheme by the exemplary system 100, but the host or administrator is afforded that option via the data output/display device 140. Further, the data output/display device 140 may be in the form of a printer or other data delivery means.

The exemplary system 100 may include one or more separate external communication interfaces 150 by which the exemplary system 100 may communicate with one or more of a plurality of user-interface devices 105 on which a user (consumer) may choose to engage with the reactive ecosystem scheme by, for example, responding to presented queries.

Communication between the external communication interface 150 and the one or more of the plurality of user interface devices 105 will typically be via wireless communication with the exemplary system 100. It is anticipated that components of the exemplary system 100 may communicate with a broad spectrum of user-interface devices that may generally be employed by each user (consumer) in executing engagement with the reactive ecosystem scheme implemented by the exemplary system 100.

The exemplary system 100 may include a worry generation unit 160 that may be used to generate queries related to linear television programs with which the queries may be associated in implementing the reactive ecosystem scheme according to this disclosure. As indicated below, quiz questions may be drawn from a database stored in one or more the data storage devices 130.

The exemplary system 100 may include a user response collection unit 170 that may be used to collect, aggregate, and otherwise score user responses received from the plurality of user-interface devices 105. Either or both of the query generation unit 160 and the user response collection unit 170 may themselves be functions of the processor 120, or may exist in the exemplary system 100 as stand-alone components.

The exemplary system 100 may include a winner selection and notification unit 180 by which, when a particular user (consumer) participating in engagement with the automated reactive ecosystem scheme by communicating responses to queries, and certain identifying information for the user (consumer) is determined to have won a prize, award, reward or the like, in the form of, for example, merchandise, discounts, coupons, cash and/or other incentives, that selection may occur based on an aggregated score for responses to those queries received from the user response collection unit 170 at which time the user (consumer) may be immediately notified by having a particular message formatted by the winner selection and notification unit 180 and transmitted to the one of the plurality of user-interface devices 105 controlled by the particular user via the external communication interface 150. Like the query generation unit 160 and the user response collection unit 170, the one or selection and notification unit 180 may be a function of the processor 120, or a stand-alone device within the exemplary system 100.

The exemplary system 100 may communicate with one or more of a plurality of user-interface devices 105, each of which may themselves include user interface, processor, communication interface, memory, and display. The user (consumer) as a player participant in the reactive ecosystem scheme implemented by the exemplary system 100 may employ a user interface device for interaction with the exemplary system 100 as it carries into effect the disclosed schemes for implementing the reactive ecosystem. It should be noted that one or more of the plurality of user-interface devices 105 by which a user (consumer) may interact with the exemplary system 100 may be any one of the many portable personal electronic devices catalogued above, and user-wearable I/O and/or computing devices such as, for example, wearable computer/communicating display glasses and/or watches, biometric sensors, virtual reality (or immersion) devices including goggles, helmets, tactile gloves and the like, and other known or developed wearable components for carrying out one or more of computing and/or communicating functions allowing user to communicate with the exemplary system 100.

All of the various components of the exemplary system 100, as depicted in FIG. 1, may be connected internally, and to one or more external components by one or more data/control busses 190. These data/control busses 190 may provide wired or wireless communication between the various components of the exemplary system 100, whether all of the components of the exemplary system 100 are housed integrally in, or are otherwise external and connected to the exemplary system 100.

It should be appreciated that, although depicted in FIG. 1 as an essentially integral unit, the various disclosed elements of the exemplary system 100 may be arranged in any combination of sub-systems as individual components or combinations of components, integral to a single unit, or external to, and in wired or wireless communication with the single unit of the exemplary system 100. Wireless communications may be by RF radio devices, optical interfaces, NFC devices and other wireless communicating devices according to RF, Wi-Fi, WiGig and other like communications protocols. In other words, no specific configuration as an integral unit, or as a support unit, is to be implied by the depiction in FIG. 1. Further, although depicted as individual units for ease of understanding of the details provided in this disclosure regarding the exemplary interface and control system 100, it should be understood that the described functions of any of the individually-depicted components may be undertaken, for example, by one or more processors 115 connected to, and in communication with, one or more data storage device(s) 120.

Audience engagement with the presented advertising content (“reactive ads”) may be enabled via the React app. The disclosed embodiments may include exemplary methods for implementing the Reactive ecosystem via an application scheme, such as the React app, hosted on a user's personal portable electronic device. FIG. 1 illustrates a flowchart of a first exemplary method. As shown in FIG. 1, operation of the method commences at Step S200 and proceeds to Step S210.

In Step S210, a user may be required to register by providing certain identification and/or demographic information to participate. This registration step is anticipated to be required only once for a particular user portable personal electronic device. In a kiosk-implemented application, the user may have to enter registration information at the kiosk to participate. Operation of the method proceeds to Step S220.

In Step S220, the React app, or other platform according to the disclosed schemes, may synchronize the user experience with the linear advertising broadcast, via known means, including but not limited to entry by the user of a code that is broadcast or otherwise distributed in association with the linear advertising broadcast. Separately, and in embodiments, the entry of the code may be effected by scanning, with a mobile device running the React app, the ad itself. In other embodiments, a code embedded within the ad (such as a QR code). Audio watermarking within the audio portion of the ad, or other means of confirming known to those familiar with the art may also be employed for receiving the code. Operation of the method proceeds to Step S230.

In Step S230, once the user is “in sync” with the advertising content, the user may be served reactive queries related to the linear advertising broadcast via the React app. Operation of the method proceeds to Step S240.

In Step S240, user answers to the queries may be received via a user interface on the user's portable personal electronic device, at the kiosk, via a wearable input/output device, or otherwise. Operation of the method proceeds to Step S250.

In Step S250, user's identification (ID) may be received with the user answers to the queries. Operation the method proceeds to Step S260.

In Step S260, the received responses, drawn from potentially millions of simultaneous users (viewers), may be aggregated and scored. Operation of the method proceeds to Step S270.

In Step S270, awards notifications may be made to a portion of the participating audience of users. Operation the method proceeds to Step S280.

In Step S280, names, likenesses, and live appearances by winners of reactive contests may be recorded for broadcast to the national audience, with an objective, among others, of reinforcing the legitimacy of the premise that reactive advertising is exciting, rewarding, and legitimate. Operation of the method proceeds to Step S290, where operation of the method ceases.

The disclosed embodiments may include a non-transitory computer-readable medium storing instructions which, when executed by a processor may cause the processor to execute all, or at least some, of the steps of the method outlined above.

Advertising synced reactive user events may be repeated over the duration of a standard television season, or according to any other scheduling scheme. Reinforcing every week that reactive advertisers are contributing to a significant change in the meaningfulness and importance of some advertising (rewarding reactive ads). In this regard, consumers, as the users of the React app or other like scheme, are rewarded for the “sacrifices” of sharing their interest in particular advertisements along with their identifying and demographic information. Given enough repetition, combined with the potential of word of rewarding reactive advertising spreading virally via social media on the same portable personal electronic device platforms on which the React app is hosted and likewise via other data exchange means, wide swaths of the public at large may become informed about, and positively inclined to participate with, reactive ads.

This disclosed schemes may not only have an effect of creating a positive attitude, toward ads and brands, but these schemes may also benefit from satisfying consumers' desires to multi-task using their portable personal electronic devices, even as their attention remains at least partially focused on the ads which will form the basis for potential rewards.

User participation in any particular reactive advertising scheme may provide for the advertiser direct and verifiable feedback as to the population actually taking in portions of their advertising in a meaningful way. With the potential for a mass audience becoming positively inclined to reacting to televise or otherwise streamed or presented ads that contain a branded alert (such as a particularly identifiable stimulus (e.g., a “React” logo, logo, tone or codes), brands and advertising agencies may be able to avail themselves of access to an increasingly embedded user base to deploy reactive advertising outside of reactive television programs, and/or to linear television with reactive ads inside of ad breaks (“React breaks”).

In embodiments, a React break may allow for viewers to “react” to quizzes about a pod of one or more ads, during a brief period of time following the end of the pod, the pod being presented separately from the linear television or lives stream of event. During the return of the television program or lives stream about, the program/event may first appear, for example, in a reduced size frame, allowing for teaser questions about the prior ads to appear in rotation in an area of the presentation of the televised content. Any combination of features may be presented around, over, or otherwise with the displayed linear content. These features may include, for example logos, a timer, and a “React Code” that may be entered into the user's React app, tied to a reactive quiz about one or more of the ads in the pod.

In embodiments, reactive queries (as quiz questions) may be drawn from a pool of questions about the ads in a pod, allowing for various permutations of multi-query quizzes. This may then allow for React break pods to be used during time-shifted programs. In embodiments, such a capability may increase the difficulty in a user being able to “cheat” the quiz by playing a reactive quiz once, and then sharing the queries and answers with others (therefore avoiding the necessity to watch the advertising by each particular user in a manner that necessitates the user's attention).

Those of skill in the art should recognize that reactive ads, as provided in this disclosure, may be deployed across other mass broadcast networks, including print, email, billboards, direct mail, radio and the like, all of which may be quickly and readily engaged via the same React app in a manner described above with only the content to which the queries are directed being provided in a different format. Again, leverage may be had by making advantageous use of the widely distributed and habitually used React app during the multi-platform TV programs. In this manner, the broadcast television programs, linear television programs and the like may help demonstrate and propagate the React app, and habituate engagement with reactive apps. All of these engagements may be tied to the same registered user, providing accurate data related to cross-media exposure to, and engagement with, mass media advertising. This process may also allow for interactions including offers, polls, couponing, and myriad other targeted promotional opportunities for brands and agencies, adapting more traditional means to advanced media.

In embodiments, a process of using the React app to explore advertising across multiple media platforms and potentially in multiple physical locations, may be further expanded to include retail exploration, and other activities for brands to engage with consumers. The React app's functionality to scan QR codes, listen, or interact via Wi-Fi, Bluetooth®, beacons, near field communications (NFC), or other forms of communication made possible by current and planned technologies within mobile and wearable devices, may, with frequent use, provide an almost emotional link of consumer satisfaction of exploration with the React app, with the ecosystem administrator or host, and with brands that act as benefactors and/or sponsors of these experiences.

To reinforce with consumers the unique, respectful and secure nature of the React ecosystem, activities undertaken by consumers that expose them to risk (or burden the process of attempting to be secure data) may be simplified, streamlined, fortified and protected by the React app. Activities such as making payments with credit or debit cards, or from checking accounts, keeping vital credentials (such as passport, social security, or driver's license details) confidential and secure, and authenticating via usernames and passwords, tokens, or other methods for securing website logins, and online or retail transactions, may also be enabled in a proprietary manner by the single interactive scheme, including via the React app.

A mobile wallet function may be provided, enabling the storage and secure use of one or multiple credit, debit, or gift card accounts, as well as peer to peer payments such as that made by applications like Venmo®, with capabilities to also securely accrue, store, and apply/spend affinity points (such as frequent use loyalty rewards points common with many large brands and retailers), or reward points for using various functions of the React app itself, may be enabled.

In embodiments, virtually any payment application may be enabled, including some as exotic as providing an ability to transact business in local currencies (such as the Berkshares, or the Bristol Pound), multiple sovereign currencies (such as the Dollar, Yen, Pound Sterling and Euro) and alternative or crypto currencies such as Bitcoin. These capabilities provided in a single data exchange scheme may widen, for example, the attractiveness of the React app, and further increase its frequency of use. An embedded ability to perform foreign currency exchange calculations and functions (as well as potentially for ALL types of currencies accepted within the ecosystem), and subsequently to transfer funds stored into and across various “pockets” within the React app mobile wallet function itself, may enable increased efficiency for React app users, particularly those transacting internationally, or seeking stability for volatile currencies held for a time in the React app. In this manner, the React app may enable transfers of funds between accounts owned by the users, including bank accounts, pooled funds accounts (where ACH transfers enable rapid and virtually costless transfers), and card-related accounts (including payroll accounts linked to employer accounts, or payroll service providers).

In embodiments, the React app, and a traditional credit card, or otherwise a powered secured smart card, such as that described in U.S. Patent Application Publication No. 2015/0363808 A1, or such as the products being offered by ScramCard, may be paired (tethered) together, providing users with additional flexibility for payments with the app and tethered cards providing a user with multiple form factors for payment transactions.

In embodiments, in instances in which one or the other of the personal mobile device and the tethered card may not be in possession of the user, either the device or the card may be usable to access the same accounts (particularly in an event that the powered card is a “wallet” card, with the ability to access multiple payment accounts). If a powered card is tethered, should either of the personal electronic device or the card lose its power source, or should the device lose connection to a network for online payment processing, the other “device” may be capable of autonomously completing the transaction.

In embodiments, the React app, enabled by an embedded mobile wallet with the ability to place orders for items to be purchased from a retail establishment (such as a restaurant), may be further enabled to allow a user to participate in a “menu gamification” system, such as that described in U.S. Patent Application Publication No. 2017/0024790.

An objective of providing a complete menu of features in a single application may be to effect of habitual use by a user (consumer) of a single centralized application that hosts, secures and rewards the user (consumer) when they engage in a combination of some or all these endeavors, thereby enable the creation of a centralized reactive ecosystem within which, for example, old attitudes of indifference to ads and brands may give way to an appreciation on the part of the users (consumers).

Consumers may be provided platforms by which to safely exchange information (under the administration of the React administrator or host) with brands, and to explore details about brands and products, on a frequent enough basis to create a meaningful, yet secure, relationship between the parties to any transaction. Brands may serve consumers with information, when requested. Consumer preferences may be shared, ads consumed, and exchanges of information that positively serve the consumers and brands alike (always initiated by consumers) may flow to a level that overall market efficiencies significantly increase.

There are at least Five Exemplary Key Actions enabled by the React app as follows. As described in general above, and as supplemented further below, the disclosed embodiments enable a suite of actions that the React app (and optional tethered traditional or powered payment cards, e.g., a branded “React Card”) in a manner not previously enabled by a single device or application. The combination of several of these functionalities may become habituated over time, and may attract and empower a sizable consumer population, in a manner that may stimulate economies; increase security and affinity between brands, merchants, and consumers; and elevate the goodwill felt by all participants in the marketplace.

The enabled actions may be defined as falling into five clusters of activities, which spell the acronym, “REACT:”
REACT
EXPLORE
AUTHENTICATE
CREDENTIAL
TRANSACT
   The following explores an overview of elements of each of these five clusters of activities:

“REACT” may define actions by which consumers engage and react with reactive campaigns distributed in the marketplace. In addition to the high visibility gamified reactive ads planned for live reality television programs, where the mass audience vies for significant prizes by competing on a game show about reactive ads, consumers may use the React app to engage with other mass advertising and mass networks (such as magazines, bulk email, direct mail, even mass-distributed product packaging). Particularly for brands that an alert to react, at the moment of first presentation of commercial content, consumers may begin enjoying reacting to commercial advertising and marketing content.

In embodiments, of the React app, users (which may be referred to as “Reacters”) may register once, permanently linking their information to all actions undertaken via the React app. The React app administrator or host may enable security and privacy measures that transparently invite consumers to share personal and behavioral information about themselves, which the React administrator or host will protect and not share in a personalized manner, in exchange for the Reacter being able to participate via the React app, in commerce-based endeavors in a rewarding manner.

The types of information collected from users may include personally identifiable, demographic, and other forms of data. The React app may also request a username, password, and mobile phone number, and a “screen name” or other username that may be made publicly available, and displayed on leaderboards or other publicly-viewed websites, displays, or television programs.

Once collected, the user (and device ID, IP address, or other unique identifier) data may be added to a unique user profile, stored to a database, and when user logs into the React app for use, the React app's actions and responses made from the device may be matched with the user. To enable a user to react to reactive advertising, the React app may be enabled to allow for the user to use a camera function to scan a proprietary or generally available QR code, a UPC code, an image, or other visual element placed within a reactive advertisement, to trigger a reactive session.

Similarly, human inaudible audio watermarking, well known in the industry, may be embedded within the advertisement and be discovered by the React app to trigger a reactive session. Reactive advertising may be presented in all mass-distributed (broadcast) media, including television, radio, pre-roll videos, print, product packaging, direct mail, email and the like. Ads may be distributed (via mail or print media, labels and the like) embedded with NFC tags or other wireless technologies that may be detected by the React app, and trigger a reactive session. Reactive ads may also display or otherwise inform (such as by voice or tone) consumers to enter a code via text, voice, or otherwise, into the React app, which may then notify the React servers to trigger a reactive session within the triggering device.

A multi-purpose QR code, which may bear a React “alert,” a watermarked QR code that informs users that the QR code is part of a reactive campaign (despite being readable by QR code scanning apps other than React), and a React code that, when entered in the React app, may bypass the need to scan, all may trigger a reactive session (see the illustration at the left). The resulting reactive session may be conducted via a web app (by using a browser in the app or device), or may display the reactive session via the React app itself, in a native fashion, among other means by which a reactive session may be commenced.

Reacters may then, for example, be rewarded with points for each “sponsored” reactive action taken, allowing the Reacters to accrue reactive points, or currency, which may later be converted to traditional currency and/or used to acquire goods and services via an affinity points system used by many brands today (including airlines, eTailers, grocers and the like).

The React app (and optionally, and online website) may be part of a brand-friendly, secure ecosystem and community that may pride itself on protecting consumers and building trust and respect between consumers and brands.

In versions of this brand-friendly membership community, Reacters may participate in one or more of these activities:
Register, select sponsor app landing page skins (so a Sponsor may display a message or link to a user whenever the app is opened), and update user registration.
Create and manage Private Reacter Profile Pages (allowing the user to communicate with the React administrator or host, and participate in entertainment experiences such as ReacTV, where TV producers may screen contestants using user profile pages).
Invite (refer) new members.
Track new member referrals (for the purposes of gaining rewards, referral points and the like).
Communicate with approved, connected members.
Review and comment on React-presented News and Updates.
Communicate with the React administrator or host (including for customer service).
Participate in Community events (chats, polls, surveys, offers, crowdsourced events and the like).
Follow and participate in real-time, React-branded events, such as TV programs, promotions, by-invitation experiences and the like.

Reacters may also react to, and engage in, reactive games, surveys, and offers, enabled to:
Preload/Load and play sync-to-TV mass media games, and access scores and leaderboards in real time.
Access/Play on-demand games (live/time shifted TV, mass media outlets), and access scores and leaderboards.
Find and play on-demand, targeted and approved Reactive Games (via in-app search).
Participate in opt-in Reactive Polls, Surveys and Ad testing hosted by React, brands or other Reacters.
Create or participate in Reacter-created and managed Polls, Quizzes and Surveys.
Participate with in-week games and polls, and access scores and leaderboards.
Participate in reactive Sports Squares games (such as described in U.S. Patent Application Publication No. 2016/0078729)

To EXPLORE, users, employing the React app, may recognize the ability of the React app's scanning and other exploration tools, outside of pure mass media advertising experiences. The QR code scanning capabilities may allow the React app to provide a more secure method by which an entire consumer population may safely scan QR codes. For example, every creator of a QR or UPC code may, due to the wide adoption of the React app, register their QR or UPC codes with the React administrator or host, so that when scanned, the React administrator or host may access a database of “safe” or “cleared” QR codes, and notify Reacters of the safety of the resulting scan in advance of redirecting the Reacter. Similarly, QR or UPC codes not registered with the React administrator or host, or containing URL's that are deemed “dangerous,” or that are, for example, tied to a URL shortener (and subsequently redirected to potentially harmful or inappropriate websites), may bear a warning to Reacters, requiring user authorization before proceeding with a redirect.

Additionally, the React app may include one or more of a mobile payment and mobile wallet sub-application, enabled to store loyalty points, digital coupons, rewards, and payment cards and/or bank accounts owned by the user. As users begin to explore the online and physical marketplace, to research and purchase goods and services, retailers, merchants and service providers may use reactive campaigns to draw Reacters who are inquisitive about the goods and services. Retail displays, eTailer websites, and product labels may display React codes, QR codes, or may enable product UPC codes, when scanned by the React code, to be redirected to authorized reactive campaigns hosted by the React administrator or host.

The React administrator or host, when a UPC code that is made “reactive” is scanned, may redirect the user to a website, online product listing, an online shopping website (that may also place the scanned product into a shopping cart), or to a reactive campaign that may include one or more video commercials, other forms of advertising, and a reactive quiz, offer, poll, and/or ability to win prizes. Affinity points may be garnered by the user for engaging in reactive retail exploration, as they may be for engaging in any endeavor that invites reaction via the React app.

With Wi-Fi, in-store beacons and other forms of communications and location tracking now deployed within retail environments, bolstered by cellular services, the ability of retailers (and brands) to locate and communicate with consumers while shopping is becoming increasingly easy to undertake. With a ubiquitous app like the React app, used by inquisitive consumers with knowledge of how to react and explore, Reacters may be enabled to share their location, demography, and personally identifiable information as part of the shopping experience, in exchange for rewards (access to reactive campaigns, contests, and affinity points), and the option to be served rewarding, reactive content. The React administrator or host may, in turn, enforce privacy and opt-in rules in a manner that may allow the React administrator or host to act as a buffer between advertisers, brands and merchants, and the Reacters.

Reacters may, for example, scan a React code, QR code, or UPC code displayed on a product package, retail display, shelf talker, menu or menu board, in-store signage, or other promotional or advertising instrument, to learn about requested, competitive or other products, enter a reactive campaign where attention is rewarded, and receive coupons, credits, or rewards to purchase products or services.

Each affiliated retail member of the React ecosystem may provide a method to integrate (API, schedule flat file dump, or other known method) with the React ecosystem (including a master member database, with data coded by the source of the retailer, and the consumer based on the consumer mobile phone number, loyalty account, credit card, or the Reacter member ID).

Each retailer may ask the Reacter if they want their information available via React's purchase history data base. If a consumer opts into the service, all receipt data may be sent to the React administrator or host for storage in a singular or distributed database. Separately, the information may be posted and stored at the retailer, as well as with the React app administrator or host. Also, the information may be made available to consumers in a reformatted basis, via the React app or website, online or via the user's consumer's mobile device. The React ecosystem, via the React app, may be enabled to then run automated queries across networks to identify clusters of common interests (implied from transaction histories or from shopping list itemization), common demographic profiles or common requests. Once identified, requests for product/service quotes may be made to vendors that have subscribed to crowdsourcing services.

One of the key functionalities of the React ecosystem, when a centralized database captures transactions from multiple outlets, may be an ability to learn more about brand, category and retailer loyalty. For example, the React app administrator or host may collect all detergent transactions, as a subset of all grocery transactions, on one or more of a dollar-measured and unit-measured basis, providing very robust information. This information may allow retailers to understand percentages of total grocery sales garnered from a particular demographic group, benchmarked against a percentage of brand and category sales obtained. In embodiments, this information may allow retailers to customize marketing to capture a greater sales percentage of a brand or category.

Reacters may enter a retail location and access their data via kiosks provided by the retailers (or partners) throughout their store(s). Retailers may have the opportunity to accept manufacturer coupons presented by consumers or create their own in-store offers to be accessed by the accounts of the consumers via kiosk, online websites or mobile devices. There may be resistance by some retailers to provide consumers with access to their transactional data, out of concern that competing retailers will have access to a consumer's transactions. However, the React ecosystem may be structured to prohibit any form of retailer access to competing retailer transactions. In embodiments, cooperating React retailers may be provided with market-wide demographic reports as to the percentage of a consumer base's retail transactions they are currently capturing, down to the category level. Targeted offers may be delivered to Reacters based on their prior purchase history. To reach these consumers, the retailer may be required to be explicitly affiliated with the React ecosystem.

Additionally, by cooperating, retailers may be able to pose questions to Reacters to learn what they can do to capture more business—with the Reacters being rewarded for responding and sharing this data. The queries may be controlled in a way that retailers may not be able to ascertain information about the identity and consumption behavior of any particular Reacter at a specific competitor, but the retailers may be able to learn how to do a better job capturing more of a Reacter's business, in general terms.

Consumers may give their permission for data to be used in the provision of additional services such as offers, discounts, rebates, product announcements, items or service available, and/or in convenience in accessing their information over multiple devices. The opted-in information provided by the consumers directly or indirectly in their behavior and transaction histories may be data mined, allowing manufacturers and marketers to tailor offers and campaigns to individuals. Alternatively, the React app administrator or host may require that all points of contact with Reacters are conducted within the React app, structured in a manner that manufacturers and marketers may only be able to access Reacters through the React app.

In an aggregate, the consumer data may provide direct insight into frequency and geographic location of purchases, purchase histories and the like. In addition, the data can be combined with other data, including online surfing habits, transactions completed, purchases made and viewing habits to personalize offers or content as well as to group habits and interests for aggregate buying opportunities. The authentication capabilities of the React app (as described in further detail below) provide additional insights into Reacter behavior.

Once grouped, the potential demand may be offered to marketers and vendors for proposals or bids based on a bulk purchases instead of individual sales. The aggregate price (including price savings due to economies of scale benefits) for a product or service may then be offered to each consumer, with the consumer confirming demand, and providing a method of payment for completion of the transaction. Conversely, marketers or vendors may make offers, which may then be offered to consumers based on the listed interest, and then demand may be confirmed with the consumer.

To AUTHENTICATE, A benefit of linking the React app and user device and personal identification, to a ubiquitous personal mobile device, and optionally, a powered smart card enabled with a one-time passcode (OTP) or other authentication technology, is the ability to engage in a new authentication process. Particularly with mass adoption, reactive authentication may lead to mass adoption by merchants and institutions seeking authentication. This may have the effect of providing a greater protection for a society or community.

As background, authentication processes may use various “factors,” each of which may increase a likelihood of authenticity of the party seeking validation. Factors include “something you know,” or a knowledge factor, “something you have,” or an ownership factor, and “something you are,” or an inference factor. Three factor authentication may therefore require, for example, a password, entered via an identified device, and a biometric attribute such as a fingerprint, all tied to a single user. Those of skill in the art do not, for example, recognize authentication requiring two “things you know,” as “two factor” authentication. Other attributes, such as “time” and “location,” may be considered by some as additional authentication factors. For example, an authentication may have a window of time during which it may be considered valid or may be validated, especially at a distinct location. This additional factor authentication may be commonly practiced when authorizing access to secured locations, but that a requirement that two devices (both capable of time stamping actions, and sharing geolocational data) may provide novel means by which more secure authentication may be provided.

The React app may provide the ability to authenticate users via several methods. Logging into the React app may require a combination of two or more of the following: entering a username (or email address), password, and biometric or other inference factor into the React app and then the device itself to further authenticate (such as via issuing a OTP, or via employing a scanning function). So, for example, a website (or section of a website for making transactions) may require authentication, and the website may be a member of the React ecosystem authentication network. Under such an arrangement, all Reacters using the React app to authenticate may agree (either on a per use basis, in all instances based on agreed upon terms and conditions, or on some combination thereof) to authorize the React app administrator or host to submit authentication data to websites using the React app authentication processes.

A Reacter, for example, may be presented with a log-in page or section, seeking a username and password from registered users, related to a website reached via a browser on a desktop computer. The website may, for example, require subsequent authentication (such as a text message and code sent to a user device). This website may identify itself as a React-enabled website. In such an instance, the user may only be required to provide the website's username tied to the user's registration details at that website. After entering the username, the website may allow Reacters to bypass the password section, and instead press a separate authorizing scheme button, such as an “I'm a Reacter” button, logging the username and then awaiting reactive authentication. On the next screen, the unofficially identified Reacter may be instructed to load, log in, and use the React app to generate a temporary OTP, which may have a defined elapsed time or actual clock time period within which it is “active.” This OTP may then be entered into a data field window on the website seeking the React OTP. The website may then pass the OTP to the React app administrator or host, and seek validation that the Reacter whose name matches the website's username, has indeed authenticated with the correct temporary OTP. A time stamp may also be provided by the authenticating website, in the event the OTP had reached expiration prior to the React app administrator or host confirming that the web visitor is indeed the Reacter that matches the name of the web visitor.

The protocol between the website and React app administrator or host may be conducted in a way that the website may transmit a user's name or other data that would correspond with a field in a React user database. User data stored in the database may include a user's name, or a special string of characters that is in common between both the website and the React administrator or host.

Another authentication means may be for the website to display a unique, session-based QR code, which the React app's user, after logging into the React app, may then scan, with the scan results being accessed by the React administrator or host. The React app administrator or host may translate the code and forward the translation to the website, along with the Reacter's website-shared name or other data, at which point the website may authenticate the user as the Reacter.

In either instance, a result of a successful authentication may be that the website authorizes access to the website (or section) and logs in the user that corresponds with the Reacter who authenticated.

The above-mentioned method may allow for some key-logging risk, particularly if conducted on a publicly available computer. The less a user types into a computer, the more secure the user's data may remain. To further eliminate risk, a website may enable a more robust multi-factor form of authentication. For example, a website may allow a Reacter to authenticate via scanning a QR code from the website's page (which is, as above, a unique one time code). The Reacter may then use a React app scanner function to scan another OTP code that may be generated elsewhere (such as from the display on powered smart card or other portable security token generator). This subsequent OTP code or QR code, created using time-based and seeded OTP, may be generated on the smart card display only after logging into the card with a security PIN known by the Reacter. The React app may then scan the code from the smart card display (or any portable OTP token with display), to verify whether the user associated with the React app is the same user associated with the smart card. If the OTP is correct, the React administrator or host may verify the identity of the user via multi-factor authentication, may translate and forward the translation of the website-presented unique code to the website, along with the Reacter's website-shared name or other data, at which point the website may authenticate the user as the Reacter.

It should be noted that, in this more robust authentication model, myriad authentication factors may be available for user authentication, including:
The IP address (and possible matched physical address) of the user logging into the website.
Time of website code scan (which is of value should the website replace codes over a distinct time frame, such that codes expire).
User's React App device ID, IP address, and GPS location (if enabled).
User unlocking of the React app device (e.g., mobile phone), possibly through use of a biometric authentication factor (e.g., a thumbprint).
User unlocking the React app.
User unlocking the portable token generator.
User scanning the OTP generated code with the matching React device.
The OTP code being time-sensitive and expiring.
   The varied factors noted above provide elements of all five forms of authentication, with redundancy in several areas.

In embodiments of the authentication process, a smart card/portable token display may use a novel form of QR code comprised of a random ones of number elements that form glyphs, or segments, used within an alphanumeric LCD (liquid crystal display). Under such a system, each character may consist of any number of segments, with each segment being individually displayed or muted to form the novel QR code. A 14-segment scheme, for example, may provide an estimated 16,384 variations of displayed segments per alphanumeric LCD character, excluding the addition of a decimal point “glyph” typically situated between digits. A 9-character display, therefore, could display approximately 8.5×10³⁷ unique “glyph” QR codes.

This “glyph” QR code method need not be limited to LCD displays; in fact, the websites presenting QR codes for scanning by the React app, and the React app administrator or host may use this method as well. The methods used to create and scan QR codes (and requisite “quiet” space between camera or machine-readable elements of a QR code) may apply within any display environment capable of displaying properly scaled and toned visual elements. An example of such a display generated by a novel QR code schemes such as that described above is provided below.

To CREDENTIAL, Reacters employing the React app, including the ability to authenticate (and optionally with a mobile wallet capable of securing credit cards), may also be empowered to use the React app to manage, display and share credentials in a highly secured manner. The React app may, for example, display or securely transmit credit card and bank account information sufficient to allow a transaction to be conducted. If widely adopted, the React app may allow users to replace traditional physical wallets with devices powered by the React app, providing a significant convenience to users (and lowering the risk of having physical credentials and payment cards stolen or copied).

By way of example, the React app administrator or host may allow Reacters to verify or upload credentials (including but not limited to passports, driver's licenses, ID cards, business cards, and professional licenses) in a secured manner to the React app administrator or host, which credentials might subsequently be displayed via the React app display, after a Reacter authenticates via the React app. Based on the type of credential, more stringent authentication (including requiring a second device such as a smart card or portable security token generator) may be required, including not displaying the credentials on the Reacter's device, but on another device or screen.

For certain credential purposes, the React app's time and location authentication capabilities may be employed, particularly to permit access to a location or event (perhaps also during a specified timeframe). Alternatively, for the purposes of official passport credentials, for example, one method of credential authentication may require that government agencies verify credentials via credential validation software available only to the government agencies. By way of example, a Reacter may be required to unlock their mobile device, unlock the React app, and then unlock the React smart card or portable security token generator. A special “credential” function button on the smart card or portable security token generator may be scanned by the React app. The combination of these steps, properly executed, may then allow the React app to display a special “credential” code or QR code that may then be scanned by the credential-seeking party. This credential-seeking party may act in cooperation with the React administrator or host, and may have access to a credential-verification application that may be used to scan the credential code, access a secured database of users, and retrieve the requisite information required of the Reacter. This requisite information may include fingerprints, social security numbers, photos, physical descriptions, medical information, military credentials, or any other type of sensate information that only the cooperating agency may be authorized to review.

In embodiments, the React administrator or host may display the Reacter's credentials on the Reacter's mobile phone or other personal electronic display device, in a manner that may not allow a “screen grab” to be taken by the Reacter.

One familiar with the art may recognize that simpler forms of credentials, such as driver's licenses, may be stored and displayed following a less rigid protocol than that outlined above, such that a Reacter's age, identity and physical likeness may be verified by police officers, retailers of age-sensitive goods (such as alcohol), or by volunteers at polling stations, as examples. Similarly, non-transferable event tickets or passes may be stored in the React app, and the venue or event host may verify the authenticity of the ticket or pass, and match the Reacter with the authorized holder of the ticket or pass, using these methods.

To TRANSACT, the inclusion of one or more transactional components, including a mobile wallet, mobile payment functionality, storage of credit/debit/gift/ATM card details, management and expenditure of loyalty points, and capabilities to link the React app to a powered smart card or other portable secured token generator, may provide users with additional commerce-related uses of the React app. By providing frequent, rewarding and beneficial transactional level activities for its users, the React app may cement in the user's mind, the React app's role as the ultimate interface with commerce-related processes. The existence of the mobile wallet may cause an increase in use of the React app as users and merchants embrace the React app and widening capabilities of the React ecosystem.

In a transactive environment, the React administrator or host may have access to user transactional information, including aggregating data tied to items purchased, amounts paid, retailers frequented, coupons redeemed, and exhibited repurchase behavior. Having collected data from advertising exposure and engagement, the React administrator or host provide end-to-end measurements concerning direct effect of branded marketing and promotions, on purchase behavior. This assessment of collected data may find applicable ability to reactive advertising as well as traditional advertising.

In embodiments, when a Reacter downloads the React App and registers, the existence of the wallet and the availability of a reloadable debit card account may be initially promoted. In other embodiments, this existence of the wallet and availability of the reloadable debit card account may be masked and deferred until mass adoption of the React app has occurred. Users may be incentivized/motivated to enable the wallet and or the reloadable debit card account according to certain preset conditions. The Reactive TV programs that attract users may be designed to demonstrate the benefits of using the React App and wallet, further adopted by loading prizes and rewards into their wallet, and also via Sponsor promotions. Users may be invited to make micropayments—and watch millions of Reacters doing so—on national television. In order to participate, Reacters may be required to link and/or load their debit card account, or access accounts being offered through the React administrator or host, and aligned financial institutions.

Reacters may be afforded an opportunity to order a physical card (either plastic, or powered) for free, or for a small fee. A powered ReactCard™ may have a modest annual fee (which may be waived according to certain conditions such as, for example, when a Reacter spends over a pre-determined amount over a period of time, or by linking the card to an employers' payroll services, such as via the DEEP Funding program described below).

The React app functionality may include one or more of these features as Transactional Options
Ability to transact cash, Bitcoin, and/or Debit wallet, with Tap and Pay functionality.
Venmo-like App and SMS Text payments, but with Cash and Bitcoin as well.
Buy and store gift cards, via cash, Credit Card, or Bitcoin.
Possible referral program rewards (e.g., $5 for every 1-3 subscribers added to the React ecosystem).

The types of Card(s) managed may include:
Physical (standard, non-powered) credit or debit card (which may include Reacters abiding by KYC (“Know Your Customer”) banking regulations prior to issuance.
Cards that may offer conversion of a crypto-currency to a sovereign currency, for uses via a credit card scheme (such as Visa or Master Card). For example, see the BitPay Visa® card: https://bitpay.com/visa/.
Physical powered smart card w/OTP functionality, as described above; with features that may include NFC tap and pay, with buttons for Cash, Bitcoin, possible Visa® Checkout/MasterPass® debit card integration or similar scheme-approved methods.

The React App functionality may include enhanced features such as:
Mobile wallet functionality (including debit/credit/ATM/gift card loading), detailed below.
Powered Card Management services (pair cards in app to buttons on card).
Mapped offers, loyalty cards.
NFC-enabled tap and pay functionality.

With users able to participate in one or more of these activities:
React and other Loyalty Points—earn, track and authorize redemption.
React Prizes—track reactive campaign entries and prizes.
Validation/Redemption/fulfillment of all React Points and prizes.
Access/Select Sponsor websites and mobile apps.
Register/link React Membership.
E-commerce/shopping cart, React items (React and Sponsor gear, offers, and shopping).
Mobile Wallet Functionality
   Authorize, link, manage and load/reload cash account, ReactCard.
   Authorize, link, manage, load/reload virtual and physical Sponsor Gift cards.
   Order/purchase/manage powered ReactCard (non-wallet and wallet version).
   Make Payments via App Wallet and/or ReactCard.
   Manage powered ReactCard Wallet functions (and link buttons, from app to card).
   Add, authorize and manage physical credit, debit and gift cards.
   Use mobile wallet to spend money from wallet-managed cards.
   Mobile phone Carrier-billing services.
   Load and transact sovereign, local and crypto currencies via app, linked cards.
Make charitable and direct micropayments.
Transfer/receive currency to/from Reacters and approved merchants.
Gift and load/reload other Reacter Sponsor Gift Cards.
Identity-theft services (prices at reduced rates for Reacters that fully utilize all authentication services, and optionally only utilize payment systems managed and authenticated by the React app and/or powered smart card or portable security token).
Universal Checkout.
E-commerce Interface.
Coupons and Coupon Redemption.
Mobile Order, In-store Pickup and Home delivery.
Gratuity payments.
Streamlined check-out.
Mobile Gifting and prepaid card purchasing.
Merchant Directory.
Store finder and Interactive Maps.
Ticket Purchase and redemption.
Bundled Goods.
Push Notification.
Favorites recall and receipts.
Access control.
Product Bundles.

In embodiments of the React ecosystem, the React app may enable management of a payroll-loadable and reloadable debit card, in standard or powered smart card form. Like services offered to employers by companies including ADP® and Instant.co, having payroll loaded into the React-linked debit card could be enhanced by also linking the payroll card to the mobile wallet and mobile payments ecosystem, allowing for greater flexibility and increasing use of the React app.

A unique aspect of wide adoption of the React app would be the ability of the React administrator or host to aggregate Reacter members in a manner that a member may request payroll be paid in this manner. Existing enterprises that offer payroll loadable cards typically rely on employer adoption, versus demand by employees.

A further enhancement might include the ability for Reacters, as employees, to receive advances of payroll from their employers, e.g., amounts earned but not yet paid. These pre-payday Draws of Employee Earned Payroll (“DEEP” funds) may be coordinated by the React administrator or host (or a contracted vendor), leveraging the size and power of the Reacter audience, in a manner that may empower and enrich Reacters by providing expedited access to payroll. The addition of a secured, powered smart card and mobile wallet, may provide a more secured method than being currently offered by traditional payroll debit cards and related services linked to bank accounts, that can be more easily accessed via hackers and thieves.

The React administrator or host may be in a unique position to enlist cooperation of employers and Reacter members, while also attracting strategic partners and technology service providers, that may be enticed to participate due to the scope of the offering. The React administrator or host, or contracted vendor, may coordinate with banks and financial institutions, to fund and secure reserve accounts used to provide advances to employees who have evidenced labor performance sufficient to support a DEEP payment. These reserve accounts may be funded by employers, or funded by other sources (with employers providing the necessary guarantees or collateral to satisfy the needs of the reserve funders).

The funds held within the React ecosystem may be held in myriad types of secured accounts, including a pooled fund method that may allow Reacters and merchants to transfer funds via a secured, lower cost method such as Automated Clearing House (ACH) transfers internal to the React ecosystem.

A multi-faceted React app, widely adopted by consumers, merchants, and financial institutions, may create a very powerful new, benevolent host of a more respectful, protecting and rewarding ecosystem, able to catalyze commerce on a massive scale. By hosting the end-to-end consumer experience, beginning with verified advertising and promotional engagement and attention, bolstered with browsing, search, retail exploration, and ending with transactional data, and even repurchase history, the React administrator or host may house one of the most fully accountable commerce-related data bases in the world.

The net result for brands may be increased product/brand loyalty, featuring rewarding, reactive experiences along the product sales and purchase lifecycle, reinforcing product repurchase, and building an affinity between brands and consumers.

We claim:

1. A system for implementing a reactive scheme, comprising:
a database that stores first data regarding broadcast media events and second data that reflect questions regarding details of the content of the broadcast media events;
a processor that is configured to recognize broadcast of the broadcast media event according to the first data, and to generate a series of questions regarding the broadcast media event;
a communication interface for establishing communication between the processor and a plurality of remote user data exchange devices, the series of questions regarding the broadcast event being transmitted to the remote user data exchange devices;
wherein:
user responses to the series of questions are received via the communication interface, and
the processor is further configured to associate user responses with identification data regarding at least one of the plurality of remote user data exchange devices, and to score the user responses.

2. The system of claim 1, wherein the processor is further configured to evaluate a highest score from the scored user responses, and to declare a winner.

3. The system of claim 2, wherein a point value to is assigned to participation by each of a plurality of users based on the user responses.

4. The system of claim 2, wherein the processor is further configured to notify the declared winner of a particular prize having been won by the declared winner.

5. The system of claim 4, data regarding the declared winner being transmitted to the one of the plurality of remote user data exchange devices associated with the winner via the communication interface.

6. The system of claim 4, wherein the particular prize is an exchangeable token stored in a storage device that identifies an account for each user.

7. The system of claim 6, wherein the account for each user is in a form of a mobile wallet.

8. The system of claim 7, the mobile wallet providing accessibility to the each user with regard to a number of transactional payment options.

9. The system of claim 1, the processor being further configured to authenticate an identity of the user prior to allowing participation of the user in a particular event.

10. The system of claim 9, where in an authentication scheme executed by the processor requires multifactor authentication prior to allowing the participation of the user in the particular event.

11. A method for implementing a reactive scheme, comprising:
establishing communication between a system coordinating the reactive scheme and at least one of a plurality of remote user interface devices;
obtaining information regarding a broadcast event;
accessing a database of questions associated with the broadcast event;
communicating questions regarding the broadcast event to the at least one of the plurality of remote user interface devices;
obtaining responses to the communicated questions regarding the broadcast event from the at least one of the plurality of remote user interface devices; and
determining an extent of user attention to the broadcast event based on the obtained responses.

12. The method of claim 11, further comprising:
assigning a point value to each of the obtained responses;
comparing a cumulative point value for the obtained responses from a first one of the plurality of remote user interface devices with a cumulative point value for the obtained responses from at least a second one of the plurality of remote user interface devices; and
determining a winner among the users of the first one of the plurality of remote user interface devices and the at least second one of the plurality of remote user interface devices.

13. The method of claim 12, further comprising:
communicating the status as a declared winner to the determined winner among the users of the first one of the plurality of remote user interface devices and the at least second one of the plurality of remote user faced devices.

14. The method of claim 11, further comprising:
collecting at least one of user identifying information and user demographic information associated with users of each of the plurality of remote user interface devices.

15. The method of claim 14, further comprising:
executing an authorization scheme based on the at least one of the collected user identifying information and the collected user demographic information.

16. The method of claim 15, the authorization scheme requiring a multi-factor authentication of each user.

17. The method of claim 14, further comprising:
aggregating data on user attention to the broadcast event with at least one of the collected user identifying information and the collected user demographic information.

18. The method of claim 13, further comprising:
notifying the declared winner of a particular prize having been won by the declared winner.

19. The method of claim 18, wherein the particular prize is an exchangeable token stored in a storage device that identifies an account for each user.

20. The method of claim 19, wherein the account for each user is in a form of a mobile wallet, the mobile wallet providing accessibility to the each user with regard to a number of transactional payment options.
